(19) United States
(12) Patent Application Publication
(10) Pub. No.: US 2014/0285955 A1
(43) Pub. Date: Sep. 25, 2014

(54) ELECTRONIC DEVICE

(71) Applicant: FUJITSU LIMITED, Kawasaki-shi (JP)

(72) Inventor: TAKASHI MATSUMOTO, Fuchu (JP)

(73) Assignee: FUJITSU LIMITED, Kawasaki-shi (JP)

(21) Appl. No.: 14/202,125

(22) Filed: Mar. 10, 2014

(30) Foreign Application Priority Data
Mar. 22, 2013 (JP) 2013-060380

(51) Int. Cl. G06F 1/16

(52) U.S. Cl. CPC G06F 1/16
USPC 361/679.01

(57) ABSTRACT

An electronic device includes a sensor board connected to a fingerprint sensor, a switch mounted at a side of the sensor board opposite the finger print sensor, a movable portion supporting the sensor board, the fingerprint sensor and the switch, a cover member provided beneath the switch and configured to depress the switch through movement of the movable portion when downward pressure is placed onto the fingerprint sensor, the cover member overlying an electrical component, the cover member and electrical component being mounted on a control board.

### CROSS-REFERENCE TO RELATED APPLICATION

This application is based upon and claims the benefit of priority of the prior Japanese Patent Application No. 2013-060380, filed on Mar. 22, 2013, the entire contents of which are incorporated herein by reference.

### FIELD

The embodiment discussed herein is related to an electronic device.

### BACKGROUND

Hitherto, there is known an electronic device having a push button, and a control board on which is mounted a switch facing the push button. In some of this type of electronic devices, the push button is provided with a fingerprint sensor. In such an electronic device, when the push button is pressed, the switch is turned on. These arts are disclosed, for example, in Japanese Laid-open Patent Publication Nos. 2008-112697, 2000-165378, and 2006-155455.

### SUMMARY

According to an aspect of the invention, an electronic device includes a sensor board connected to a fingerprint sensor, a switch mounted at a side of the sensor board opposite the finger print sensor, a movable portion supporting the sensor board, the fingerprint sensor and the switch, a cover member provided beneath the switch and configured to depress the switch through movement of the movable portion when downward pressure is placed onto the fingerprint sensor, the cover member overlying an electrical component, the cover member and electrical component being mounted on a control board.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a rear view of an electronic device; and

FIG. 2 is a sectional view taken along line 2-2 of FIG. 1.

### DESCRIPTION OF EMBODIMENT

In the case of an electronic device such as that of the related art, in order to avoid the interference with the push button, a component other than the switch may not be mounted on a part of the control board facing the push button. Therefore, there is a problem that components may not be efficiently disposed on the control board, and the control board increases in size.

In order to solve this problem, it is conceivable to dispose, separately from the control board, a switch board on which the switch is mounted between the control board and the push button. However, in this case, although components may be efficiently disposed on the control board, there is a problem that the electronic device increases in thickness.

An embodiment of the present disclosure will now be described.

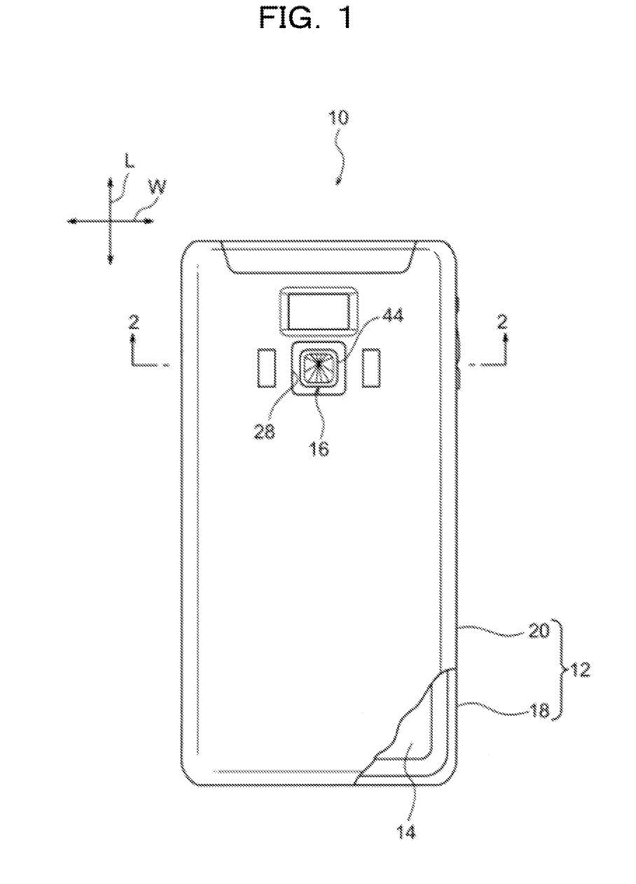

An electronic device 10 according to this embodiment illustrated in FIG. 1 is, for example, a mobile phone terminal. The electronic device 10 includes a housing 12, a control board 14, and a sensor unit 16. The arrows L, W, and T in each figure respectively indicate the length direction, width direction, and thickness direction of the electronic device 10.

The housing 12 has a front case 18 and a rear case 20. The housing 12 is divided in the thickness direction thereof into the front case 18 and the rear case 20. A display unit such as a liquid crystal display unit is attached to the front case 18. The control board 14 and so forth are housed inside the front case 18 and the rear case 20. The display unit attached to the front case 18 is controlled by the control board 14.

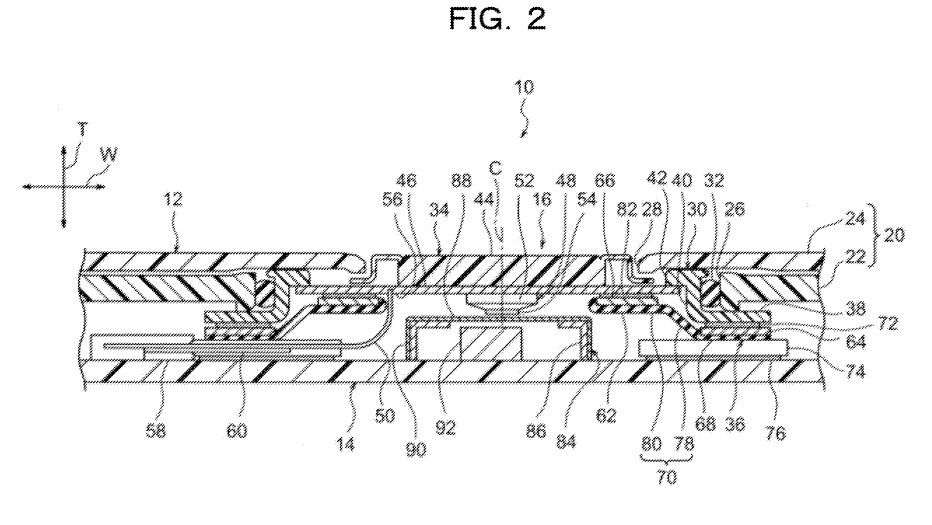

As illustrated in FIG. 2, the rear case 20 has a case main body portion 22 and an exterior panel 24. The exterior panel 24 is provided on the outer side of the case main body portion 22, and is attached so as to be superimposed on the case main body portion 22. The case main body portion 22 has an opening 26 formed therethrough in the thickness direction. The exterior panel 24 has an opening 28 formed therethrough in the thickness direction at a position corresponding to the opening 26. The opening 26 of the case main body portion 22 is formed larger than the opening 28 of the exterior panel 24.

The sensor unit 16 has a holder member 30, an O-ring 32, a fingerprint sensor module 34, and a supporting member 36. The holder member 30 is made of resin and has a frame portion 38, a standing wall portion 40, and a locking portion 42. The frame portion 38 is formed in a frame shape along the circumferential direction of the opening 26 formed in the case main body portion 22. The frame portion 38 is attached to the peripheral edge of the opening 26 from the control board 14 side.

The standing wall portion 40 is formed such that the height direction thereof is the penetrating direction of the opening 26, and extends from the inner periphery of the frame portion 38 to the exterior panel 24 side. The standing wall portion 40 is formed in a looped shape along the circumferential direction of the opening 26 formed in the case main body portion 22, and is disposed within the opening 26. The locking portion 42 extends from the distal end of the standing wall portion 40 toward the inside of the standing wall portion 40. The locking portion 42 is formed over the entire circumference of the standing wall portion 40 formed in a looped shape.

The O-ring 32 is attached to the outer periphery of the standing wall portion 40, and is interposed in a close contact state between the inner periphery of the opening 26 and the outer periphery of the standing wall portion 40. The space between the inner periphery of the opening 26 and the outer periphery of the standing wall portion 40 is sealed by the 0-ring 32.

The fingerprint sensor module 34 has a fingerprint sensor 44, a sensor board 46, a switch 48, and a wiring member 50. The fingerprint sensor 44 has a plurality of electrodes arranged in a matrix in the vertical direction and horizontal direction of the fingerprint sensor 44, and is mounted on one side (the side opposite to the control board 14) of the sensor board 46. When a finger touches the fingerprint sensor 44, the fingerprint sensor 44 outputs a signal corresponding to the positions of ridges and grooves of the fingerprint.

The sensor board 46 is disposed such that the thickness direction thereof is the penetrating direction of the opening 26. The sensor board 46 is disposed on the inner side of the standing wall portion 40 formed in a looped shape. The switch 48 is mounted on the other side (the side facing the control board 14) of the sensor board 46. The switch 48 is a push-button switch, and has a main body portion 52 fixed to the sensor board 46 and a movable portion 54 that moves relative to the main body portion 52 in the thickness direction of the sensor board 46.

When the movable portion 54 is depressed toward the sensor board 46, the switch 48 is turned on, and a switch-on signal is output from the switch 48. The positions of the fingerprint sensor 44 and the switch 48 are set such that the central part of the above-described fingerprint sensor 44 is located on the central axis C of the switch 48.

The fingerprint sensor 44 and the switch 48 are mounted on the sensor board 46, and are thereby connected with a conductive portion 56 (conductive pattern) formed on the sensor board 46. The wiring member 50 is, for example, a flexible flat cable, and connects the conductive portion 56 and a connector 58. The connector 58 is an example of a connecting portion, and is mounted on one side (the side facing the sensor board 46) of the control board 14. The wiring member 50 extends from the sensor board 46 through the inside of an arm portion 70 formed in the supporting member 36 described later to the connector 58. A reinforcing plate 60 is provided in a connection part of the wiring member 50 with the connector 58.

The supporting member 36 has a rubber portion 62 and reinforcing members 64 and 66. The rubber portion 62 is made of rubber, and has a fixing portion 68 and an arm portion 70. The fixing portion 68 is formed in a looped shape along the circumferential direction of the frame portion 38. The fixing portion 68 is provided with the reinforcing member 64 formed in a looped shape along the circumferential direction of the fixing portion 68. The reinforcing member 64 is bonded to the fixing portion 68 by a double-sided tape 72, and the supporting member 36 is thereby attached to the holder member 30.

A spacer 74 is provided on one side (the side facing the sensor board 46) of the control board 14. The spacer 74 is bonded to the control board 14 by a double-sided tape 76. The double-sided tapes 72 and 76 both have the sealing performance (waterproof performance and dustproof performance). The frame portion 38 of the holder member 30, the fixing portion 68 of the supporting member 36, and the reinforcing member 64 described above are sandwiched between the peripheral edge of the opening 26 formed in the case main body portion 22 and the spacer 74.

The arm portion 70 of the supporting member 36 has an inclined portion 78 extending from the inner periphery of the fixing portion 68 toward the sensor board 46 and an extending portion 80 extending from the distal end of the inclined portion 78 toward the central part of the sensor board 46 (toward the switch 48). The inclined portion 78 is inclined with respect to the axial direction of the supporting member 36 so as to approach the sensor board 46 toward the inside of the supporting member 36. The whole arm portion 70 having the inclined portion 78 and the extending portion 80 is formed in a looped shape around the central axis of the switch 48.

The extending portion 80 is provided with the reinforcing member 66 formed in a looped shape along the circumferential direction of the extending portion 80. The reinforcing member 66 is bonded to the other side (the side facing the control board 14) of the sensor board 46 by a double-sided tape 82, and the sensor board 46 is thereby attached to the supporting member 36.

The arm portion 70 elastically supports the sensor board 46 such that the sensor board 46 may come into and out of contact with the control board 14, and the sensor board 46 is biased by the arm portion 70 away from the control board 14. When no load is applied on the fingerprint sensor 44 toward the control board 14, the peripheral edge of the sensor board 46 is locked with the locking portion 42. By locking the peripheral edge of the sensor board 46 with the locking portion 42, the sensor board 46 is restricted from moving away from the control board 14. When the peripheral edge of the sensor board 46 is locked with the locking portion 42, the above-described fingerprint sensor 44 is disposed within the opening 28.

The control board 14 is disposed on the side of the sensor board 46 opposite to the fingerprint sensor 44, and faces the sensor board 46. A shield member 84 that is an example of a cover member is provided on one side (the side facing the sensor board 46) of the control board 14. The shield member 84 is provided opposite to the switch 48, and is fixed to the control board 14 by a fixing member 86.

The shield member 84 is formed in a box shape having a top wall portion 88 extending along the control board 14 and a side wall portion 90 formed on the peripheral edge of the top wall portion. The shield member 84 covers a mounted component 92 mounted on the control board 14. The mounted component 92 is, for example, an arithmetic element.

The shield member 84 is formed of a material having at least one of electrostatic, electromagnetic, and magnetic shielding properties. The shielding property of the shield member 84 is selected according to the function of the mounted component 92. The shield member 84 may be formed of sheet metal, or may be formed of resin and may then be coated with a shielding material.

When the peripheral edge of the sensor board 46 is locked with the locking portion 42, the shield member 84 is separated from the above-described switch 48. When a load is applied on the fingerprint sensor 44 and the sensor board 46 moves toward the control board 14, the movement of the sensor board 46 toward the control board 14 brings the switch 48 into contact with the top wall portion 88, and the switch 48 is depressed by the shield member 84. That is, the movable portion 54 is pressed and moved toward the sensor board 46, and the switch 48 is turned on. The top wall portion 88 facing the movable portion 54 of the switch 48 is formed so as to extend further in the extending directions (longitudinal and lateral directions) of the control board 14 than the movable portion 54. The shield member 84 is disposed on the inner side of the arm portion 70 formed in a looped shape.

Next, the operation and effects of this embodiment will be described.

As described above in detail, according to this embodiment, the switch 48 is mounted on the sensor board 46, and the control board 14 is provided with a shield member 84 that is disposed opposite to the switch 48 and that depresses the switch 48. A mounted component 92 covered by the shield member 84 is mounted on a part of the control board 14 facing the switch 48. Therefore, the inside of the shield member 84 is used as a mounting part for the mounted component 92, and components may be efficiently disposed on the control board 14. The control board 14 may thereby be reduced in size.

Since the switch 48 is mounted on the sensor board 46, a pattern desired for the connection of the switch 48 may be omitted from the control board 14. Therefore, also owing to this, components may be efficiently disposed on the control board 14, and the control board 14 may be reduced in size.

In addition, in the electronic device 10, along the thickness direction of the control board 14, the fingerprint sensor 44, the sensor board 46, the switch 48, the shield member 84, and the control board 14 are arranged in this order. Therefore, as compared, for example, to a case where, separately from the control board 14, a switch board on which the switch 48 is mounted is added between the control board 14 and the sensor board 46, the increase in thickness of the electronic device 10 may be suppressed (the electronic device 10 may be reduced in thickness).

The supporting member 36 has an arm portion 70 formed in a looped shape around the central axis of the switch 48, and the shield member 84 is disposed on the inner side of the arm portion 70. Therefore, as compared, for example, to a case where the shield member 84 and the arm portion 70 are arranged in the thickness direction of the control board 14, the increase in thickness of the electronic device 10 may be suppressed.

The shield member 84 has a function of shielding the mounted component 92 in addition to the function of depressing the switch 48. Therefore, a depressing member for depressing the switch 48 and a shield member for shielding the mounted component 92 do not have to be separately provided, and therefore the number of components may be reduced.

By mounting the switch 48 on the sensor board 46, the fingerprint sensor 44, the sensor board 46, and the switch 48 are modularized as a fingerprint sensor module 34. Therefore, the fingerprint sensor module 34 may be used as a common component between the electronic device 10 of this embodiment and another electronic device. The cost may thereby be reduced.

The switch 48 is mounted on the side of the sensor board 46 opposite to the fingerprint sensor 44, and the fingerprint sensor 44 and the switch 48 are mounted on the common sensor board 46. Therefore, as compared, for example, to a case where the fingerprint sensor 44 and the switch 48 are mounted on separate boards, the positional accuracy of the fingerprint sensor 44 and the switch 48 may be improved.

That is, for example, in a case where the fingerprint sensor 44 and the switch 48 are mounted on separate boards, the assembling error between the boards affects the relative positions of the fingerprint sensor 44 and the switch 48 in addition to the mounting error of the fingerprint sensor 44 and the switch 48 relative to the boards. On the other hand, in a case where the fingerprint sensor 44 and the switch 48 are mounted on a common sensor board 46 as in this embodiment, only the mounting error of the fingerprint sensor 44 and the switch 48 relative to the sensor board 46 affects the relative positions of the fingerprint sensor 44 and the switch 48. Therefore, factors affecting the relative positions of the fingerprint sensor 44 and the switch 48 may be reduced, and therefore the positional accuracy of the fingerprint sensor 44 and the switch 48 may be improved.

The switch 48 is mounted on the sensor board 46 such that the central part of the fingerprint sensor 44 is located on the central axis C of the switch 48. Therefore, the central part of the fingerprint sensor 44 is aligned with the central part of the switch 48, and therefore the operability when pressing the fingerprint sensor 44 and thereby causing the shield member 84 to depress the switch 48 may be improved.

The top wall portion 88 of the shield member 84 is formed so as to extend further in the extending directions (longitudinal and lateral directions) of the control board 14 than the movable portion 54 of the switch 48. Therefore, if, owing to the mounting error of the shield member 84, the shield member 84 is misaligned from the switch 48 in the extending directions of the control board 14, the movable portion 54 of the switch 48 and the top wall portion 88 may be kept facing each other. A state where the switch 48 is depressed by the shield member 84 may thereby be kept.

Next, a modification of this embodiment will be described.

Although, in the above-described embodiment, a shield member 84 is used as an example of a cover member that depresses the switch 48, a cover member does not have to have a shielding property as long as it covers the mounted component 92 on the control board 14.

Although the electronic device 10 is, for example, a mobile phone terminal, the electronic device 10 may be any electronic device other than a mobile phone terminal.

Although the embodiment of the present disclosure has been described, the present disclosure is not limited to the above-described embodiment. It goes without saying that various changes may be made without departing from the spirit of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An electronic device comprising:
a sensor board connected to a fingerprint sensor;
a switch mounted at a side of the sensor board opposite the finger print sensor;
a movable portion supporting the sensor board, the fingerprint sensor and the switch;
a cover member provided beneath the switch and configured to depress the switch through movement of the movable portion when downward pressure is placed onto the fingerprint sensor;
the cover member overlying an electrical component;
the cover member and electrical component being mounted on a control board.

2. The electronic device according to claim 1,
wherein the finger print sensor, the sensor board and the switch form a finger print sensor module; and
the electrical component is an element not directly related to the function of the finger print sensor module.

3. The electronic device according to claim 1, further comprising:
a wiring member which electrically connects the sensor board to the control board through a connector mounted at the control board;
the connector being smaller than the sensor board; and
the sensor board, wiring member, connector and control board are configured so as to convey data received from the finger print sensor from the sensor board to the control board.

4. The electronic device according to claim 1, wherein the cover member that encapsulates the electrical component, and the cover member is formed of a material having at least one of electrostatic, electromagnetic, and magnetic shielding properties.

5. The electronic device according to claim 1, wherein the movable portion having an arm portion that is formed in a looped shape surrounding the switch and that elastically supports the sensor board such that the sensor board is configured to move toward with the control board when downward pressure is placed on the finger print sensor,
wherein the cover member is disposed within the looped shape of the arm position.

6. The electronic device according to claim 1, the cover member has a top wall portion configured to depress a movable portion of the switch when downward pressure is placed on the finger print sensor.

7. The electronic device according to claim 1, wherein the switch is mounted on the sensor board such that a center of the fingerprint sensor overlies a central axis of the switch.

8. The electronic device according to claim 1, wherein the fingerprint sensor, the sensor board, and the switch form a modularized fingerprint sensor module.
